(19) United States
(12) Patent Application Publication
(10) Pub. No.: US 2005/0256216 A1
(43) Pub. Date: Nov. 17, 2005

(54) Production of polystyrene for foaming applications using a combination of peroxide initiators

(76) Inventors: Douglas A. Berti, Houston, TX (US); Jose M. Sosa, Deer Park, TX (US); Jay Reimers, Houston, TX (US)

Correspondence Address: FINA TECHNOLOGY INC, PO BOX 674412, HOUSTON, TX, 77267-4412, US

(21) Appl. No.: 10/846,050

(22) Filed: May 14, 2004

(51) Int. Cl. C08J 9/00

(52) U.S. Cl. 521/99

(57) ABSTRACT

It has been discovered that improved polystyrene products may be obtained by polymerizing styrene in the presence of at least one multifunctional initiator that is trifunctional or tetrafunctional and at least one lower functionality initiator that is difunctional or monofunctional. These polymers may have increased Mz, increased MFI, and increased MWD. Optionally the resin may include at least one chain transfer agent, at least one cross-linking agent and/or a styrene-conjugated diene-styrene block copolymer. The presence of the multifunctional initiator tends to cause more branched structures in the polystyrene.

### FIELD OF THE INVENTION

The present invention is related to methods and compositions useful to improve the manufacture of polystyrene and copolymers of styrene. It relates more particularly to methods of polymerizing and copolymerizing styrene monomer with multifunctional initiators and lower functionality initiators in the optional presence of crosslinking agents, chain transfer agents and/or a styrene-conjugated diene-styrene block copolymer.

### BACKGROUND OF THE INVENTION

The polymerization of styrene is a very important industrial process that supplies materials used to create a wide variety of polystyrene-containing articles. This expansive use of polystyrene results from the ability to control the polymerization process. Thus, variations in the polymerization process conditions are of utmost importance since they in turn allow control over the physical properties of the resulting polymer. The resulting physical properties determine the suitability of polystyrene for a particular use. For a given product, several physical characteristics must be balanced to achieve a suitable polystyrene material. Among the properties that must be controlled and balanced are weight-averaged molecular weight (Mw) of the polymer, molecular weight distribution (MWD), melt flow index (MFI), and the storage modulus (G′).

The relationship between the molecular weight and the storage modulus is of particular importance in polymer foam applications. Such foam applications require high molecular weight polymers having a high storage modulus. It is thought that the storage modulus is related to the degree of branching along the polymer chain. As the degree of branching increases, the likelihood that a branch entangles with other polymer chains increases. A polymer product having a higher degree of branching or cross-linking tends to have a higher storage modulus and, therefore, better foam stability characteristics.

Methods for preparing branched polymers are known in the art. For example, the preparation of branched polystyrene by free radical polymerization has been reported. This method increases the branching in the devolatilization step and produces a polymer with an undesirably low molecular weight.

Rather than employing free radical polymerization, some have used multi-functional mercaptans to form branched polymers. While materials having an acceptable molecular weight can be prepared by this method, these products are unacceptable for foam applications due to their undesirable flow properties.

The properties of randomly branched polystyrene prepared in the presence of divinylbenzene have been reported by Rubens (L. C. Rubens, Journal of Cellular Physics, pp 311-320, 1965). However, polymers having a useful combination of molecular weight and cross-linking are not attainable. At low concentrations of divinylbenzene, low molecular weight polymers having little branching result. However, higher concentrations of the cross-linking agent result in excessive cross-linking and concomitant gel formation that is highly undesirable in industrial polystyrene processes. Similar results and problems were reported by Ferri and Lomellini (J. Rheol. 43(6), 1999).

A wide variety of peroxy compounds is known from the literature as initiators for the production of styrenic polymers. Commercially available initiators for polymer production may be classified in different chemical groups, which include diacylperoxides, peroxydicarbonates, dialkylperoxides, peroxyesters, peroxyketals, and hydroperoxides. Peroxides and hydroperoxides undergo at least four reactions in the presence of monomers or hydrocarbons with double bonds. These reactions are: 1) chain transfer, 2) addition to monomer, 3) hydrogen abstraction, and 4) re-combination, often called a cage effect.

Hydroperoxides have been shown to undergo induced decomposition reactions, in which a polymer radical (˜˜P*) will react with the initiator as shown below. This reaction is basically a chain transfer reaction and the reaction should be amenable to the well-known chain transfer equations. Radicals obtained from peroxide initiators (RCOO*) can also abstract a hydrogen from the hydroperoxide.
RCOO* or ˜˜P*+RCOOH→˜˜PH+ROO*
Baysal and Tobolsky (Journal of Polymer Science, Vol. 8, p. 529 et seq., (1952), incorporated by reference herein) investigated the chain transfer of polystyryl radicals to t-butyl hydroperoxide (t-BHP), cumyl hydroperoxide (CHP), benzoyl peroxide (Bz₂O₂), and azobisisobutyronitrile (AIBN). AIBN and benzoyl peroxide give the classical linear correlations between rate and 1/DP (Degree of Polymerization) indicating no chain transfer to initiators. The hydroperoxides, however, show significant levels of chain transfer.

A. I. Lowell and J. R. Price (Journal of Polymer Science, Vol. 43, p. 1, et seq. (1960), incorporated by reference herein) also showed that polystyryl radicals undergo considerable chain transfer with bis(2,4-dichloro)benzoyl peroxide as compared to dilauroyl peroxide.

Commercial polystyrene made by the conventional free-radical process yields linear structures. As noted, methods to prepare branched polystyrenes, however, are not easily optimized and few commercial non-linear polystyrenes are known. Studies of branched polymers show that these polymers possess unique molecular weight-viscosity relationships due to the potential for increased molecular entanglements. Depending upon the number and length of the branches, non-linear structures can give melt strengths equivalent to that of linear polymers at slightly higher melt flows.

U.S. Pat. No. 6,353,066 to Sosa describes a method of producing a co-polymer by placing a vinylbenzene (e.g. styrene) in a reactor, placing a cross-linking agent (e.g. divinylbenzene) in the reactor, and placing a chain transfer agent (e.g. mercaptan) in the reactor and forming a polyvinylbenzene in the presence of the cross-linking agent and chain transfer agent.

It would be desirable if methods could be devised or discovered to provide vinylaromatic polymers with increased branching, such as branched polystyrene with improved properties. It would also be helpful if a method could be devised that would help optimize the physical properties of vinylaromatic polymers having increased branching. Such polymers may have a higher melt strength than polymers of linear chains, and may improve processability and mechanical properties of the final product (e.g. increase density in foam application).

### SUMMARY OF THE INVENTION

There is provided, in one form, a method for producing a foamed, polymerized product that involves polymerizing at least one vinylaromatic monomer in the presence of at least one multifunctional initiator that is a trifunctional or tetrafunctional initiator, and at least one lower functionality initiator that is a difunctional or monofunctional initiator. A blowing agent may also be used to foam the polymerized product. The recovered foamed, polymerized product may have a Mz of at least 400,000 and a MFI of greater than about 3 and a MWD of from about 2.5 to about 4.0. Alternatively, in another non-limiting embodiment, the recovered foamed, polymerized product may have a Mz of at least 500,000 and a MFI of greater than about 3.5.

In another embodiment of the invention, there is provided a vinylaromatic monomer resin that includes at least one vinylaromatic monomer, at least one multifunctional initiator that is a trifunctional or tetrafunctional initiator, and at least one lower functionality initiator that is a difunctional or monofunctional initiator. The resin has at least one additional component that is either a chain transfer agent, a crosslinking agent, or a styrene-conjugated-diene-styrene block copolymer.

In another embodiment of the invention, there is provided a vinylaromatic/diene graft copolymer made by polymerizing at least one vinylaromatic monomer with at least one polydiene, in the presence of at least one multifunctional initiator and at least one lower functionality initiator. Again the multifunctional initiator may be a trifunctional or a tetrafunctional initiator. The lower functionality initiator may be a difunctional or a monofunctional initiator. A polymerized product is recovered.

In still another embodiment of the invention, there is provided a foamed article made from the vinylaromatic monomer resin or the vinylaromatic/diene graft copolymer described above.

### DETAILED DESCRIPTION OF THE INVENTION

The inventors have explored the potential for providing branched polystyrene having at least some increased branching by using tetrafunctional initiators or trifunctional initiators together with lower functionality initiators, and optionally, chain transfer agents, cross-linking agents and/or styrene-conjugated diene-styrene block copolymers. The invention concerns initiating a vinyl aromatic monomer such as styrene in various solvents and in the optional presence of a polydiene, such as polybutadiene or a styrene/butadiene copolymer, with a mixture of a multifunctional initiator (e.g. tri- or tetrafunctional) and a more conventional lower functionality initiator, to thereby use the multifunctional initiator to obtain branched structures.

In theory, tetrafunctional materials can be schematically represented by the shape of a cross. If at the end of each arm of the cross, the potential for initiation or chain transfer exists, it is possible to envision polystyrene molecules that will have higher molecular weight than by using bifunctional initiators only. Similarly to tetrafunctional initiators, trifunctional initiators simply have three “arms” or starting points instead of the four found in tetrafunctional initiators. Difunctional and monofunctional initiators tend to have a more linear structure, although many difunctional initiators have the functional groups extending from a cycloalkyl structure.

In the present case, relatively small levels of the tetrafunctional initiators are used to optimize the melt properties resulting from the formation of branched structures. With the tetrafunctional initiator, four linear chains for one branched molecule are formed. At high levels of initiators the amount of linear chains, initiated by the alkyl radicals, will lower the effect brought by the branched chains, initiated by the tetrafunctional radicals.

Styrene polymerization processes are known in general. The compositions of the invention can be made by batch polymerization in the presence of multifunctional initiators at concentrations of from about 100 to about 1200 ppm and a lower functionality initiator and using a solvent. In another non-limiting embodiment of the invention the concentration of multifunctional initiator may range from about 100 to about 600 ppm. The lower functionality initiator may be present in a concentration of from about 50 to about 1000 ppm, and in another non-limiting embodiment, the lower functionality initiator concentration range may be from about 100 to about 600 ppm

In one non-limiting embodiment of the invention, the multifunctional initiator is a trifunctional or tetrafunctional peroxide and is selected from the group consisting of tri- or tetrakis t-alkylperoxycarbonates, tri- or tetrakis-(t-butylperoxycarbonyloxy) methane, tri- or tetrakis-(t-butylperoxycarbonyloxy)butane, tri- or tetrakis(t-amylperoxycarbonyloxy)butane, tri- or tetrakis(t-C₄₋₆ alkyl monoperoxycarbonates) and tri or tetrakis(polyether peroxycarbonate), and mixtures thereof. In one non-limiting embodiment of the invention, the tetrafunctional initiator has four t-alkyl terminal groups, where the t-alkyl groups are t-butyl and the initiator has a poly(methyl ethoxy) ether central moiety with 1 to 4 (methyl ethoxy) units. This molecule is designated herein as LUPEROX® JWEB 50 and is available from Atofina Petrochemicals, Inc. Another commercial product suitable as a multifunctional initiator is 2,2 bis(4,4-di-(tert-butyl-peroxy-cyclohexyl)propane) from Akzo Nobel Chemicals Inc., 3000 South Riverside Plaza Chicago, Ill., 60606. Another commercial product is 3,3′,4,4′ tetra(t-butyl-peroxy-carboxy)benzophenone from NOF Corporation, Yebisu Garden Place Tower, 20-3 Ebisu 4-chome, Shibuya-ku, Tokyo 150-6019.

Hydroperoxides and peroxydicarbonates, peroxyesters, peroxyketals, dialkyl peroxides lower functionality initiators useful in making the invention include peroxide initiators having a half-life of one hour at 110-190° C., including, but not necessarily limited to, difunctional initiators 1,1-di-(t-butylperoxy)cyclohexane (Lupersol® 331 catalyst or L-331 available from ATOFINA Chemicals, Inc.); 1,1-di-(t-amylperoxy)cyclohexane (Lupersol® 531 or L-531 available from ATOFINA Chemicals, Inc.); ethyl-3,3-di(t-butylperoxy)butyrate (Lupersol® 233 or L-233 available from ATOFINA Chemicals, Inc.); t-amyl peroxy-2-ethylhexyl carbonate (Lupersol® TAEC), t-butylperoxy isopropyl carbonate (Lupersol® TBIC), OO-t-butyl 1-(2-ethylhexyl)monoperoxy carbonate (Lupersol® TBEC), t-butyl perbenzoate; 1,1-di-(t-butylperoxy)-3,3,5-trimethyl-cyclohexane (Lupersol® 231 catalyst or L-231 available from ATOFINA Chemicals, Inc.); ethyl-3,3-di(t-amylperoxy)butyrate (Lupersol 533), di-isopropyl benzene monohydroperoxide (DIBMH), and Trigonox® 17 (N-butyl-4,4-di(t-butylperoxy)valerate). Other lower functionality initiators that can be used with the method of the present invention include peroxides with one hour half-lives ranging from 60 to 150° C. from diacyl peroxides, diazo compounds, peroxydicarbonates, peroxyesters, dialkylperoxides, hydroperoxides, and perketals. Mixtures of these initiators can also be used.

Non-grafting initiators are also used with the present invention. Exemplary non-grafting initiators include, but are not necessarily limited to, 2,2′-azobis(isobutyronitrile) (AIBN), 2,2′-azobis(2-methylbutyronitrile) (AMBN), lauroyl peroxide, and decanoyl peroxide. Mixtures of these initiators can also be used.

For the purposes of the present invention, the terms “grafting” and “non-grafting” as used above relate to the ability of an initiator to promote both the homopolymerization of styrene and the reaction of polymerizing styrene to react with residual unsaturation in the styrene-butadiene-styrene copolymer, if any. For the purposes of the present invention, a grafting polymerization initialization initiator is one that promotes both the initialization of styrene and the reaction of styrene or polystyrene with the residual unsaturation in a styrene-butadiene-styrene copolymer. Similarly, for the purposes of the present invention, a non-grafting polymerization initialization initiator is one that promotes the initialization of styrene, but does not materially promote the reaction of styrene or polystyrene with the residual unsaturation in a styrene-butadiene-styrene copolymer.

Suitable optional solvents for the polymerization include, but are not necessarily limited to ethylbenzene, xylenes, toluene, hexane and cyclohexane.

The goals of this invention include, but are not necessarily limited to, providing polystyrene and similar polymers for foaming applications or for high impact applications where the polymer has a melt flow index (MFI) of greater than about 3 in one non-limiting embodiment, and in an alternate non-limiting embodiment greater than about 3.5, for polymers with some branching. In the case of linear polystyrene homopolymers, a MFI range of from about 1.5 to about 2 is a goal. In one non-limiting embodiment of the invention, a MFI of 3.5 with an Mz of 600,000 gives an acceptable melt strength at an increase in production rate of 20%.

Other goals include producing a polymerized product such as polystyrene that has a molecular weight distribution (MWD) of about 2.4 or greater in one non-limiting embodiment, and greater than about 3 in another non-limiting embodiment of the invention. Additionally, a further goal is to provide a polymerized product such as polystyrene that has a z-average molecular weight (Mz) greater than about 500,000 g/gmol, and in an alternate non-limiting embodiment greater than about 600,000 g/gmol. One method to measure molecular weights is referred to as size exclusion chromatography (SEC) available from the Waters Corp., Milford Mass. The standard procedure is to calibrate chromatographic columns using narrow molecular weight standards, Mw/Mn=1.1-1.3, and Mn ranges from =580 to 7,000,000 Daltons. Since Mz is a calculated number, it can be higher than what is calibrated for; however, an upper limit for Mz is 8,000,000 for all practical purposes. Generally, when producing polymers the minimum average molecular weight is the goal, and average molecular weights that are higher are usually quite acceptable. Normally, the lowest Mn value for the purposes of this invention is 60,000, so that the highest possible Mz/Mn ratio for the inventive formulations is probably: Mz/Mn ratio=133. The highest Mw/Mn ratio for the conditions used in the inventive method is about 4, possibly up to about 5. In one non-limiting embodiment of the invention, a Mn of about 95,000; an Mw of about 330,000 and an Mz of about 500,000 would be desirable values. Such values would give preferred ratios of Mw/Mn of about 3.5; Mz/Mw of about 1.8, and Mz/Mn of about 5.3. In an alternative, non-limiting embodiment of the invention, suitable ranges for Mw/Mn would be from about 2.5 to about 4; for Mz/Mw from about 1.5 to about 2.5, and for Mz/Mn from about 4 to about 8.

Furthermore, in another non-limiting embodiment of the invention, the ratio Mz/Mn may be above about 4.1, and alternatively above about 6.0. Additionally, in another non-limiting embodiment of the invention, the ratio Mz/Mw may be above about 1.7, and alternatively above about 2.5.

The polystyrenes of the present invention are particularly well suited for preparing polymer foams. In preparing polymer foams, the polymer is admixed with a blowing agent and the blowing agent functions to produce cells which lower the density of the polymer. Blowing agents useful for producing polymer foams include gases and liquids that are gases under blowing conditions, such as butane, carbon dioxide, chlorofluorocarbons, fluorocarbons, pentane, and hexane. In another non-limiting embodiment of the invention, the blowing agents are relatively high vapor pressure blowing agents, e.g. CO₂. The polystyrenes of the present invention have excellent melt strength which allows the polymer to more efficiently retain the blowing agents which in turn can reduce production costs by reducing processing time and raw material costs.

In one non-limiting embodiment of the invention, the chain transfer agent is preferably a member of the mercaptan family. Particularly useful mercaptans include, but are not necessarily limited to, n-octyl mercaptan, t-octyl mercaptan, n-decyl mercaptan, n-dodecyl mercaptan (NDM), t-dodecyl mercaptan, tridecyl mercaptan, tetradecyl mercaptan, n-hexadecyl mercaptan, t-nonyl mercaptan, ethyl mercaptan, isopropyl mercaptan, t butyl mercaptan, cyclohexyl mercaptan, benzyl mercaptan and mixtures thereof. In advantageous embodiments, the concentration of the chain transfer agent may range from about 0 ppm to about 800 ppm by weight based on the total amount of vinyl aromatic monomers; in one embodiment of the invention, up to about 800 ppm, and in another embodiment of the invention from about 25 to about 800 ppm. In another non-limiting embodiment of the inventtion, the concentration of the chain transfer agent may range from about 100 ppm to about 400 ppm. Again, if the concentration of chain transfer agent is too low, the storage modulus, G′, is not improved and gelation may occur due to the presence of DVB, if present (divinylbenzene). However, if the concentration is too high the molecular weight Mw of the resulting polymer is too low to use to manufacture certain products.

In one embodiment the vinylbenzene may be styrene and an optional cross-linking agent may be a divinylbenzene (DVB). Other suitable cross-linking agents include, but are not necessarily limited to, 1,9-decadiene; 1,7-octadiene; 2,4,6-triallyloxy-1,3,5-triazine; pentaerythritol triacrylate (PETA); ethylene glycol diacrylate; ethylene glycol dimethacrylate; triethylene glycol diacrylate; tetraethylene glycol dimethacrylate; and mixtures thereof. One who is skilled in the art understands that substituted vinylbenzene and substituted divinylbenzene molecules or other tri- or tetrafunctional monomers may also be employed as cross-linking agents. The concentration of the cross-linking agent in the mixture may vary. However, in a preferred embodiment, the cross-linking agent's concentration may range from about 0 ppm to about 400 ppm in one non-limiting embodiment, up to 400 ppm in an alternate embodiment, from about 25 to about 400 ppm in yet another embodiment, and in another non-limiting embodiment may range from about 25 ppm to about 250 ppm. If the concentration of the cross-linking agent is too low the molecular weight, Mw of the resulting polymer may be too low, and if the concentration of the cross-linking agent is too high an undesirable gel may form, as noted previously.

It has been discovered that multifunctional initiators can be used together with chain transfer agents and cross-linking agents to manufacture polystyrene and HIPS that is more highly branched. The chain transfer agent and/or cross-linking agent may be added prior to, during or after the initiator is added to the monomer.

It has also been discovered that the polymerization of a vinyl aromatic monomer such as styrene carried out in the presence of divinylbenzene (DVB) and n-dodecyl mercaptan (NDM) to produced branched structures as disclosed in U.S. Pat. No. 6,353,066 (incorporated by reference herein) can be improved by using a tetrafunctional initiator and a lower functionality initiator in combination with DVB and NDM. Extensive studies have been done to determine the conditions suitable for optimizing the melt rheology, however, it has been surprisingly found that an increase in rate can be produced while obtaining the desired molecular parameters.

Another, alternate embodiment of the present invention includes dissolving or incorporating a styrene-butadiene-styrene copolymer in the vinyl aromatic monomer. In one embodiment of the present invention, styrene-butadiene-styrene copolymers useful with the process of the present invention are those having the general formula:
S—B—S
where S is styrene and B is butadiene or isoprene. In another embodiment of the present invention, the styrene-butadiene-styrene copolymers have the general formula:
(SB)ₙX.
where X stands for the residue of a coupling agent; and n is more than 1. In a first embodiment of the present invention where such a radial styrene-butadiene-styrene copolymer is used, n is an integer ranging from about 2 to about 40. In another such embodiment, n is an integer ranging from about 2 to 4 or 5. The styrene-butadiene-styrene copolymers useful with the process of the present inventtion can have a molecular weight ranging from about 2,000 to about 300,000 Daltons. In one embodiment of the present invention, the styrene-butadiene-styrene polymers useful with the present invention have a molecular weight of from about 50,000 to about 250,000 Daltons. In still another embodiment, the styrene-butadiene-styrene polymers useful with the present invention have a molecular weight of from about 75,000 to about 200,000 Daltons.

For purposes of the present invention, the term styrene-butadiene-styrene includes the compositions where the butadiene component is isoprene and also compositions where the butadiene element is a mixture of butadiene or another conjugated diene. While the vast majority of S—B—S copolymers utilize butadiene as the B component, any conjugated diene can be used in the present application and is within the scope of the claims.

The styrene-butadiene-styrene block copolymers useful with the present invention have a styrene content of at least 50 percent. In one embodiment, the styrene-butadiene-styrene block copolymers useful with the present invention have a styrene content of from about 60 to about 80 percent. In another embodiment, the styrene-butadiene-styrene block copolymers useful with the present invention have a styrene content of from about 65 to about 75 percent.

The styrene-butadiene-styrene block copolymers useful with the present invention may have a tapered block structure and may also be, at least in some embodiments, partially hydrogenated. In tapered block copolymers, each block should contain predominantly only one component, S or B. In each block, the presence of the non-predominant or minor component is less than 5 weight percent. If hydrogenated, then the styrene-butadiene-styrene block copolymers will have some or even most of the residual unsaturation removed from the butadiene segment of the copolymer. Examples of styrene-butadiene-styrene copolymers useful with the present invention include those sold under the trade designations FINACLEAR® and FINAPRENE®, sold by ATOFINA; KRATON® polymers, sold by KRATON POLYMERS LLP; and K-Resins, sold by B&K Resins, Ltd.

A suitable proportion of the styrene-butadiene-styrene block copolymers optionally used herein ranges up to about 10%, in another non-limiting embodiment, up to about 7%, and in a third non-limiting embodiment up to about 3%.

In making the certain compositions of the invention, batch or continuous polymerizations can be conducted in 97:3 to 91:9 styrene to rubber, 85:15 to 80:20 typical styrene solvent mixtures to 60-80% styrene conversion to polystyrene and then flashing off the unreacted monomer and the solvent. In a non-limiting, typical preparation, 3-12% of rubber is dissolved in styrene, then about 10% ethylbenzene is added as 90:10 styrene:ethylbenzene. The ethylbenzene is used as a diluent. Other hydrocarbons can also be used as solvents or diluents. In another non-limiting embodiment of the invention, the polymerization is conducted at a temperature between about 110° C. and about 185° C.; alternatively between about 110° C. and about 170° C. A possible temperature profile to be followed in producing the subject compositions is about 110° C. for about 120 minutes, about 130° C. for about 60 minutes, and about 150° C. for about 60 minutes, in one non-limiting embodiment. The polymer is then dried and devolatilized by conventional means. Although batch polymerizations are used to describe the invention, the reactions described can be carried out in continuous units, as the one described by Sosa and Nichols in U.S. Pat. No. 4,777,210, incorporated by reference herein.

The invention will now be described further with respect to actual Examples that are intended simply to further illustrate the invention and not limit it in any way.

### EXAMPLES 1-9

In this study, formulations for the production of low melt flow crystal polystyrene were made. A monofunctional percarbonate (TAEC) and a tetrafunctional percarbonate (JWEB 50) were screened in combination with conventional initiators L531 and L533. The standard initiator composition used was 200 ppm L531 and 50 ppm L533. The tetrafunctional initiator JWEB 50 appears to increase molecular weights as expected.

The objective was to utilize the rates in increasing production rates in low melt flow crystal polystyrene. Different combinations of initiators were compared to study the polymerization rates with the presently used L531 and L533 combination in the production of low melt flow crystal polystyrene (PS). Lab conditions used for the production of low melt flow materials under batch polymerizations were employed. The temperature ramp conditions employed were 70 min. at 100® C.; 180 min. at 110° C.; 75 min. at 120° C.; and 80 min. at 130° C. These ramp conditions were designed to obtain crystal PS with a melt flow close to 2.0 and do not necessarily reveal what % PS conversions can be expected in different reactors under CSTR conditions. The final conversions in these reactions are in the 80-90% range. The reactor samples are devolatilized under standard conditions. Samples for % PS conversions were taken at the end of each temperature ramp, and additionally at the midpoint (90 min.) of 110° C. ramp. Equivalent levels of peroxides were used for all the initiators compared. A L533 replacements used was JWEB 50, and JWEB 50 and TAEC were the new initiators replacements for L531.

TABLE I
Initiator Related Information

| | | Functionality | Chemical | 1 hr | 10 hr |
|---|---|---|---|---|---|
| Initiator | Chemical Name | multiplicity | Class | half life | half life |
| Lupersol 531 | 1,1-di-(t-amylperoxy)cyclohexane | difunctional | perketal | 112 | 93 |
| Lupersol 231 | 1,1-di-(t-butylperoxy)-3,3,5-trimethylcyclohexane | difunctional | perketal | 115 | 96 |
| Lupersol TAEC | OO-t-amyl-O-(2-ethylhexyl)monoperoxycarbonate | monofunctional | percarbonate | 117 | 99 |
| Lupersol JWEB 50 | see text | tetrafunctional | percarbonate | 119 | |
| Lupersol 533 | ethyl-3,3-di(t-amylperoxy)butyrate | difunctional | perketal | 132 | 112 |

TAEC and JWEB 50 were chosen as the percarbonates to be used in combination with the presently used initiator(s). The overall results are shown in Table II. It was found that monofunctional TAEC can be used interchangeably with L531 with a potential for slightly higher polymerization rates in the early reactors, even though TAEC is a monofunctional initiator. The TAEC/L531/L533 initiator combination (Example 9) provided a polymerization rate comparable to the standard L531/L533 combination (Example 1), whereas the rates with JWEB 50 combinations (Examples 4, 5, 6 and 7) were slightly lower. Polymerization rates are lower with L231 relative to those for L531. The results show that the short lived life span of L231 can be compensated for by the addition of TAEC and JWEB 50 which are more active in the temperature range used than L533 (Example 7).

TABLE II
Polymerization Data and Product Characterization Results (Typical Mol. Wt of Commercial
low melt flow crystal polystyrene: Mn, 135000; Mw: 335000; Mz, 553000)

| | Ex. | | | | | | | | |
|---|---|---|---|---|---|---|---|---|---|
| | Comp. 1 | Comp. 2 | Comp. 3 | Inv. 4 | Inv. 5 | Inv. 6 | Inv. 7 | Comp. 8 | Comp. 9 |
| Initiator | (200/L531 + | (210/L231 + | (360/TAEC + | (200/L531 + | (210/L231 + | (360/TAEC + | (140/L231 + | (140/L231 + | (143/L531 + |
| | 50/L533) | 50/L533) | 50/L533) | 75/JWEB50) | 75/JWEB50) | 75/JWEB50) | 120/TAEC + | 120/TAEC + | 120/TAEC + |
| | | | | | | | 75/JWEB50) | 50/L533) | 50/L533) |
| 1^{st} Conv. | 3.64 | 1.87 | 4.66 | 4.66 | 0 | 0 | 0 | 0 | 0 |
| 2^{nd} Conv. | 26.4 | 23.0 | 24.4 | 25.3 | 23.2 | 22.7 | 25.8 | 20.8 | 25.3 |
| 3^{rd} Conv. | 47.3 | 39.5 | 44.6 | 44.0 | 41.8 | 42.3 | 47.9 | 40.0 | 44.6 |
| 4^{th} Conv. | 75.6 | 57.7 | 71.7 | 65.3 | 66.3 | 69.1 | 75.8 | 63.3 | 73.7 |
| 5^{th} Conv. | 85.5 | 80.0 | 93.0 | 84.2 | 80.6 | 82.1 | 89.4 | 83.6 | 84.6 |
| Melt Flow | 1.93 | 2.44 | 2.39 | 2.01 | 1.87 | 2 | 2.71 | 1.95 | 2.02 |
| Mn (pellet) | 97530 | 92050 | 104340 | 104720 | 121100 | 135250 | 127590 | 123470 | 124170 |
| Mw (pellet) | 273080 | 308830 | 272890 | 333000 | 345360 | 355690 | 329300 | 334700 | 331650 |
| Mz (pellet) | 476290 | 544300 | 463700 | 584620 | 603550 | 600640 | 558125 | 556330 | 550720 |
| MWD(plt) | 2.8 | 3.36 | 2.65 | 3.18 | 2.85 | 2.63 | 2.58 | 2.71 | 2.67 |
| Mn (110 C.) | 159830 | 151450 | 147050 | 163460 | 161860 | 150730 | 144890 | 140270 | 169050 |
| Mw (110 C.) | 344850 | 341630 | 319070 | 356340 | 356730 | 324220 | 343820 | 329620 | 341240 |
| Mz (110 C.) | 539350 | 532160 | 487700 | 556630 | 554840 | 495130 | 554440 | 516850 | 522920 |
| MWD(110 C.) | 2.16 | 2.26 | 2.17 | 2.18 | 2.32 | 2.2 | 2.37 | 2.35 | 2.02 |

Comparison of standard formulation for low melt flow crystal polystyrene (using conventional initiators L531 and L533) with formulations utilizing new initiators, suggests that the best of the formulations using new initiators show performance equivalent to the currently utilized formulation as long as equivalent peroxide amounts are used. Replacement of a portion of L531 by monofunctional percarbonate TAEC provides essentially identical rates but the molecular weights seem to be higher with the new combination. This result is unexpected, since TAEC is monofunctional; this outcome strongly suggests that other interactions occur that are often difficult to predict using current understanding. Use of tetrafunctional JWEB 50 in place of L533 (Example 5) does provide higher molecular weights under the experimental conditions. Use of a combination of monofunctional initiator (for example, TAEC) and tetrafunctional initiator (JWEB 50) also provides a viable initiator system for replacing L531 and L533 combination (Example 6).

### EXAMPLES 10-13

The first level of addition tried was 500 ppm. For this level, an equal active oxygen amount of L531 was removed from the formulation. This introduction immediately increased both the z-average molecular weight, although still not high enough to meet the goal, and the distribution. Further increases to the amount of JWEB used, as in experiments 12 and 13, increased the z-average molecular weight and distribution again, and resulted in materials that met the goal for molecular weight distribution, but fell short of the z-average molecular weight goal.

TABLE III
High Molecular Weight PS using Difunctional
and Tetrafunctional Initiators

| | Example | | | |
|---|---|---|---|---|
| | Comp. 10 | Inventive 11 | Inv. 12 | Inv. 13 |
| Styrene, | 100 | 100 | 100 | 100 |
| % | | | | |
| Initiator | L531/L533 | L531/L533/JWEB | L533/JWEB | L533/JWEB |
| Type | 350/65 | 175/65/500 | 65/1000 | 65/1000 |
| (ppm) | | | | |
| Production | 70 | 75 | 78 | 79 |
| Rate | | | | |
| (lb/h) | | | | |
| MFI | 1.6 | 3.07 | 3.08 | 3.25 |
| (g/10 min) | | | | |

Molecular Weights (g/gmol)

| | | | | |
|---|---|---|---|---|
| Mn/1000 | 147 | 90 | 89 | 89 |
| Mw/1000 | 310 | 272 | 284 | 276 |
| Mz/1000 | 486 | 485 | 536 | 510 |

Molecular Weight Ratios

| | | | | |
|---|---|---|---|---|
| MWD | 2.1 | 3.0 | 3.2 | 3.1 |
| Mz/Mn | 3.3 | 5.4 | 6.0 | 5.7 |
| Mz/Mw | 1.6 | 1.8 | 1.9 | 1.8 |

### EXAMPLES 14-20

In these Examples, high Mz material was made using a combination of JWEB and Luperox 531, and in a separate experiment by using a small amount of Finaclear 530, a di-block polystyrene-butadiene copolymer that can be an optional, additional component in some embodiments of the invention. Both approaches are known to increase the amount of long-chain branching. Chain transfer agent NDM was used to increase the melt flow and broaden the molecular weight distribution.

The addition of NDM both increased the melt flow and broadened the molecular weight distribution. After preparing material with this formulation, another trial was conducted with Finaclear 530—adding it to a different high molecular weight PS base resin formulation (Example 18). The addition of a small amount of Finaclear 530, less than 5% by weight, has been shown to increase the Mz in prior work.

A summary of the Examples and the final pellet analyses appear in Table IV. Example 14 established the baseline for the high molecular weight crystal PS similar to Example 10 using Luperox 531 and Luperox 533. Eliminating the L533 and substituting JWEB 50 at 400 ppm in the second experiment (Example 15) produced very high Mz values, but alone did not broaden the molecular weight distribution or result in a higher melt flow. To increase the melt flow and broaden the distribution NDM was added. While producing the desired effect on the melt flow and distribution, the introduction of NDM significantly reduced the Mz—below the target molecular weight. To increase the Mz, the residence time was increased in the pre-polymer while decreasing the temperature to maintain the same conversion in Example 17. This had a positive effect on the Mz, but not a pronounced one.

Noting from past experiments from polystyrene research that the addition of a small fraction of a di-block polystyrene-butadiene polymer (Finaclear 530) increases the Mz, the next experiments were devoted to this approach. After obtaining a second baseline for a somewhat different high molecular weight PS in Example 18, 2% of Finaclear 530 was added to the formulation, with NDM still being added to the first reactor. This resulted in a melt flow out of the goal range. Eliminating the NDM allowed the target melt flow to be reached and resulted in a high Mz. It was interesting to note that the Mz increased in the post reactor and devolatilization section with the use of Finaclear. This was thought to be due to grafting at the higher temperatures.

TABLE IV
High Molecular Weight PS using Difunctional and Tetrafunctional Initiators

| | Ex. | | | | | | |
|---|---|---|---|---|---|---|---|
| | Comp. 14 | Inv. 15 | Inv. 16 | Inv. 17 | Comp. 18 | Comp. 19 | Comp. 20 |
| Styrene, % | 100 | 100 | 100 | 100 | 100 | 98 | 98 |
| Finaclear | — | — | — | — | — | 2 | 2 |
| Initiator Type | L531/L533 | L531/JWEB | L531/JWEB | L531/JWEB | L233 | L233 | L233 |
| (ppm) | 350/65 | 400/400 | 400/400 | 400/400 | 100 | 100 | 100 |
| NDM (ppm) | — | — | 500 | 500 | — | 500 | — |
| MFI, g/10 min | 1.57 | 1.16 | 3.53 | 3.12 | 3.8 | 5.64 | 3.45 |

Molecular Weights, g/gmol

| | | | | | | | |
|---|---|---|---|---|---|---|---|
| Mn/1000 | 135 | 135 | 99 | 99 | 88 | 85 | 96 |
| Mw/1000 | 288 | 326 | 241 | 256 | 243 | 230 | 263 |
| Mz/1000 | 453 | 548 | 420 | 459 | 409 | 456 | 540 |

Molecular Weight Ratios

| | | | | | | | |
|---|---|---|---|---|---|---|---|
| MWD | 2.1 | 2.4 | 2.4 | 2.6 | 2.8 | 2.7 | 2.7 |
| Mz/Mn | 3.4 | 4.1 | 4.2 | 4.6 | 4.6 | 5.3 | 5.6 |
| Mz/Mw | 1.6 | 1.7 | 1.7 | 1.8 | 1.7 | 2.0 | 2.0 |

### EXAMPLES 21-25

It is a continuing goal to provide polystyrene for use in a dense foam application. This polystyrene should have a z-average molecular weight in excess of 600,000 g/gmol and a MWD is greater than 3.0. This material should have a melt strength of 0.08 N at an initial temperature of 225° C. as measured by the well-known Rheoten Melt Drawing Apparatus. Examples 19 and 20 were performed as noted above to increase the molecular weight by the introduction of Finaclear 530—a styrene/butadiene copolymer. The necessary amount of Finaclear to approach the target melt strength was 7%. Beside the aforementioned runs with Finaclear, additional runs were performed with tert-butylstyrene (TBS), which contains small amounts of diisopropenylbenzene and isopropenyl-styrene, divinylbenzene (DVB), and JWEB, a tetra-functional initiator.

A summary of the Examples and the molecular weights of the pellets, melt flows, as well as the melt strengths of some of the products, appear in Table V. Given the goals of the experiment, it was important during each run to note both production rate and the pressure in the post-reactor. The process conditions for baseline productions of both the high molecular weight PS comparable to Example 14 and the high molecular weight PS comparable to Example 18, respectively, appear in the first two columns—Examples 21 and 22, respectively. Example 23 contained 600 ppm of JWEB, 300 ppm of DVB, and 100 ppm of NDM. The pressure in the post-reactor was comparable to Example 21, but the production rates were 40% higher. The melt strength was not quite as high as that of Example 21, but the melt flow was much higher. 860 ppm of JWEB was introduced in the subsequent run, Example 24. This produced the necessary melt strength to meet the target. A combination of 4% Finaclear and 400 ppm of JWEB also gave a similar melt strength in Example 25.

TABLE V
High Molecular Weight PS using Difunctional
and Tetrafunctional Initiators

| | Example | | | | |
|---|---|---|---|---|---|
| | 21 | 22 | 23 | 24 | 25 |
| Styrene, % | 100 | 100 | 100 | 100 | 96 |
| Finaclear, | 0 | 0 | 0 | 0 | 4 |
| wt % | | | | | |
| Initiator | L531/L533 | L233 | JWEB 50 | JWEB 50 | JWEB 50 |
| Type (ppm) | 350/65 | 100 | 600 | 860 | 400 |
| NDM, ppm | 0 | 0 | 300 | 0 | 0 |
| DVB, ppm | 0 | 0 | 100 | 0 | 0 |
| Production | 70 | 96 | 98 | 99 | 96 |
| Rate (lb/h) | | | | | |
| MFI | 1.57 | 3.66 | 3.40 | 2.59 | 2.62 |
| (g/10 min) | | | | | |
| Melt | 0.062 | — | 0.054 | 0.063 | 0.057 |
| Strength | | | | | |
| (N@225 C.) | | | | | |
| Line Speed | 271 | — | 177 | — | — |
| (m/min) | | | | | |

Molecular Weights (g/gmol)

| | | | | | |
|---|---|---|---|---|---|
| Mn/1000 | 135 | 92 | 92 | 111 | 112 |
| Mw/1000 | 288 | 241 | 284 | 311 | 297 |
| Mz/1000 | 453 | 396 | 597 | 620 | 567 |

Molecular Weight Ratios

| | | | | | |
|---|---|---|---|---|---|
| MWD | 2.1 | 2.6 | 3.1 | 2.8 | 2.7 |
| Mz/Mn | 3.4 | 4.3 | 6.5 | 5.6 | 5.0 |
| Mz/Mw | 1.6 | 1.6 | 2.1 | 2.0 | 1.9 |

The resins of this invention are expected to find use in foam applications where increased branching, higher Mz and higher MWD are needed. Specific foam applications include, but are not necessarily limited to, insulation foam boards, cups, plates, food packaging. The styrene-based polymers of the present invention are expected to find use in other injection molded or extrusion molded articles. Thus, the styrene-based polymers of the present invention may be widely and effectively used as materials for injection molding, extrusion molding or sheet molding. It is also expected that the polymer resins of this invention can be used as molding material in the fields of various different products, including, but not necessarily limited to, household goods, electrical appliances and the like.

In the foregoing specification, the invention has been described with reference to specific embodiments thereof, and has been demonstrated as effective in providing methods for preparing polymers using combinations of initiators with various functionalities. However, it will be evident that various modifications and changes can be made thereto without departing from the scope of the invention as set forth in the appended claims. Accordingly, the specification is to be regarded in an illustrative rather than a restrictive sense. For example, specific combinations or amounts of vinylaromatic monomers, multifunctional peroxide initiators, lower functionality initiators, chain transfer agents, cross-linking agents, styrene-conjugated diene-styrene block copolymers and other components falling within the claimed parameters, but not specifically identified or tried in a particular polymer system, are anticipated and expected to be within the scope of this invention. Further, the methods of the invention are expected to work at conditions, particularly temperature, pressure and proportion conditions, other than those exemplified herein.

1. A method for producing a foamed, polymerized product comprising polymerizing at least one vinylaromatic monomer in the presence of at least one multifunctional initiator selected from the group consisting of trifunctional and tetrafunctional initiators, and at least one lower functionality initiator selected from the group consisting of difunctional and monofunctional initiators, and foaming the polymerized product with a blowing agent; and recovering a foamed, polymerized product having a Mz of at least about 400,000 and a MFI of greater than about 3 and a MWD of from about 2.5 to about 4.0.

2. The method of claim 1 where the vinylaromatic monomer is styrene.

3. The method of claim 1 where the multifunctional initiator is selected from the group consisting of tri- or tetrakis t-alkylperoxycarbonates, tri- or tetrakis (polyether peroxycarbonate), tri- or tetrakis-(t-butylperoxycarbonyloxy)methane, tri- or tetrakis-(t-butylperoxycarbonyloxy)butane, tri- or tetrakis(t-amylperoxycarbonyloxy) butane and tri- or tetrakis(t-C₄₋₆ alkyl monoperoxycarbonates), and mixtures thereof.

4. The method of claim 1 where the multifunctional initiator is present in an amount ranging from about 100 to about 1200 ppm, based on the vinylaromatic monomer.

5. The method of claim 1 where the polymerized product is more highly branched as compared with a polymerized product made by an otherwise identical method except that a multifunctional initiator is not used.

6. The method of claim 1 where the lower functionality initiator is selected from the group consisting of mono- and difunctional hydroperoxide, peroxydicarbonates, peroxyesters, peroxyketals, dialkyl peroxides diacyl peroxides, diazo compounds, peroxydicarbonates, peroxyesters, dialkylperoxides, hydroperoxides, perketals, and mixtures thereof.

7. The method of claim 1 where the lower functionality initiator is present in an amount ranging from about 50 to about 1000 ppm, based on the vinylaromatic monomer.

8. The method of claim 1 further comprising polymerizing the vinylaromatic monomer in the presence of at least one chain transfer agent.

9. The method of claim 1 where the chain transfer agent is a mercaptan.

10. The method of claim 9 where the chain transfer agent is selected from the group consisting of n-octyl mercaptan, t-octyl mercaptan, n-dodecyl mercaptan (NDM), t-dodecyl mercaptan, tridecyl mercaptan, tetradecyl mercaptan, n-hexadecyl mercaptan, n-decyl mercaptan, t-nonyl mercaptan, ethyl mercaptan, isopropyl mercaptan, t butyl mercaptan, cyclohexyl mercaptan, benzyl mercaptan and mixtures thereof.

11. The method of claim 9 where the chain transfer agent is added in an amount up to about 800 ppm, based on the vinylaromatic monomer.

12. The method of claim 1 where in polymerizing the monomer, the polymerizing is conducted at a temperature between about 110° C. and about 185° C.

13. The method of claim 1 polymerizing the vinylaromatic monomer in the presence of a cross-linking agent selected from the group consisting of polyfunctional monomers with two or more vinyl groups.

14. The method of claim 13 where the cross-linking agent is selected from the group consisting of divinyl benzene (DVB), 1,9-decadiene, 1,7-octadiene, 2,4,6-triallyloxy-1,3,5-triazine, pentaerythritol triacrylate (PETA), ethylene glycol diacrylate, ethylene glycol dimethacrylate, triethylene glycol diacrylate, tetraethylene glycol dimethacrylate, and mixtures thereof, and the concentration of the cross-linking agent ranges from about 25 ppm to about 400 ppm, based on the vinyl monomer.

15. The method of claim 1 further comprising polymerizing the vinylaromatic monomer in the additional presence of a styrene-butadiene-styrene block copolymer.

16. The method of claim 15 wherein the styrene-butadiene-styrene block copolymer has a general formula:
S—B—S
where S is styrene and B is butadiene or isoprene.

17. The method of claim 15 wherein the styrene-butadiene-styrene block copolymer has a general formula:
(SB)ₙX
where X stands for the residue of a coupling agent; and n is more than 1.

18. The method of claim 16 wherein the styrene-butadiene-styrene block copolymer has a molecular weight range of from about 2,000 to 300,000 Daltons.

19. The method of claim 15 wherein the styrene-butadiene-styrene block copolymer has a styrene content of at least 50 percent.

20. The method of claim 15 wherein the styrene-butadiene-styrene block copolymer is a tapered block copolymer.

21. A vinylaromatic monomer resin comprising at least one vinylaromatic monomer, at least one multifunctional initiator selected from the group consisting of trifunctional and tetrafunctional initiators, and at least one lower functionality initiator selected from the group consisting of difunctional and monofunctional initiators, and at least one additional component selected from the group consisting of at least one chain transfer agent, at least one crosslinking agent, and at least one styrene-conjugated-diene-styrene block copolymer.

22. The resin of claim 21 where the vinylaromatic monomer is styrene.

23. The resin of claim 21 where the multifunctional initiator is selected from the group consisting of tri- or tetrakis t-alkylperoxycarbonates, tri- or tetrakis (polyether peroxycarbonate), tri- or tetrakis-(t-butylperoxycarbonyloxy)methane, tri- or tetrakis-(t-butylperoxycarbonyloxy)butane, tri- or tetrakis(t-amylperoxycarbonyloxy)butane and tri- or tetrakis(t-C₄₋₆ alkyl monoperoxycarbonates), and mixtures thereof.

24. The resin of claim 21 where the multifunctional initiator is present in an amount ranging from about 100 to about 1200 ppm, based on the vinylaromatic monomer.

25. The resin of claim 21 where the polymerized product from the resin is more highly branched as compared with a polymerized product made by an otherwise identical method except that a multifunctional initiator is not used.

26. The resin of claim 21 where the lower functionality initiator is selected from the group consisting of mono- and difunctional hydroperoxide, peroxydicarbonates, peroxyesters, peroxyketals, dialkyl peroxides diacyl peroxides, diazo compounds, peroxydicarbonates, peroxyesters, dialkylperoxides, hydroperoxides, perketals, and mixtures thereof.

27. The resin of claim 21 where the lower functionality initiator is present in an amount ranging from about 50 to about 100 ppm, based on the vinylaromatic monomer.

28. The resin of claim 21 where the additional component is a chain transfer agent that is a mercaptan.

29. The resin of claim 28 where the chain transfer agent is selected from the group consisting of n-octyl mercaptan, t-octyl mercaptan, n-dodecyl mercaptan (NDM), t-dodecyl mercaptan, tridecyl mercaptan, tetradecyl mercaptan, n-hexadecyl mercaptan, n-decyl mercaptan, t-nonyl mercaptan, ethyl mercaptan, isopropyl mercaptan, t butyl mercaptan, cyclohexyl mercaptan, benzyl mercaptan and mixtures thereof.

30. The resin of claim 28 where the chain transfer agent is added in an amount up to about 800 ppm, based on the vinylaromatic monomer.

31. The resin of claim 21 where the additional component is a cross-linking agent selected from the group consisting of polyfunctional monomers with two or more vinyl groups.

32. The resin of claim 31 where the cross-linking agent is selected from the group consisting of divinyl benzene (DVB), 1,9-decadiene, 1,7-octadiene, 2,4,6-triallyloxy-1,3,5-triazine, pentaerythritol triacrylate (PETA), ethylene glycol diacrylate, ethylene glycol dimethacrylate, triethylene glycol diacrylate, tetraethylene glycol dimethacrylate, and mixtures thereof, and the concentration of the cross-linking agent ranges from about 25 ppm to about 400 ppm, based on the vinyl monomer.

33. The resin of claim 21 where the additional component is a styrene-conjugated diene-styrene block copolymer where the conjugated diene is butadiene.

34. The resin of claim 33 wherein the styrene-butadiene-styrene block copolymer has a general formula:
S—B—S
where S is styrene and B is butadiene or isoprene.

35. The resin of claim 33 wherein the styrene-butadiene-styrene block copolymer has a general formula:
(SB)ₙX
where X stands for the residue of a coupling agent; and n is more than 1.

36. The resin of claim 33 wherein the styrene-butadiene-styrene block copolymer has a molecular weight range of from about 2,000 to 300,000 Daltons.

37. The resin of claim 33 wherein the styrene-butadiene-styrene block copolymer has a styrene content of at least 50 percent.

38. The resin of claim 33 wherein the styrene-butadiene-styrene block copolymer is a tapered block copolymer.

39. A vinylaromatic/diene graft copolymer made by the method comprising:
polymerizing at least one vinylaromatic monomer with at least one polydiene, in the presence of
at least one multifunctional initiator selected from the group consisting of trifunctional and tetrafunctional initiators, and
at least one lower functionality initiator selected from the group consisting of difunctional and monofunctional initiators.
recovering a polymerized product.

40. The copolymer of claim 39 where in polymerizing the vinylaromatic monomer with the polydiene, the vinylaromatic monomer is styrene and the polydiene is butadiene.

41. The copolymer of claim 39 where in polymerizing the vinylaromatic monomer with the polydiene, the multifunctional initiator is selected from the group consisting of tri or tetrakis t-alkylperoxycarbonates, tri- or tetrakis (polyether peroxycarbonate), tri or tetrakis-(t-butylperoxycarbonyloxy)methane, tri or tetrakis-(t-butylperoxycarbonyloxy)butane, tri or tetrakis(t-amylperoxycarbonyloxy)butane and tri or tetrakis(t-C₄₋₆ alkyl monoperoxycarbonates, and mixtures thereof.

42. The copolymer of claim 39 where the copolymerized product is more highly branched as compared with a copolymerized product made by an otherwise identical method except that a multifunctional initiator is not used.

43. The copolymer of claim 39 where the multifunctional initiator is present in an amount ranging from about 100 to about 1200 ppm, based on the vinylaromatic monomer.

44. The copolymer of claim 39 where the lower functionality initiator is selected from the group consisting of mono- and difunctional hydroperoxide, peroxydicarbonates, peroxyesters, peroxyketals, dialkyl peroxides diacyl peroxides, diazo compounds, peroxydicarbonates, peroxyesters, dialkylperoxides, hydroperoxides, perketals, and mixtures thereof.

45. The copolymer of claim 39 where the lower functionality initiator is present in an amount ranging from about 50 to about 1000 ppm, based on the vinylaromatic monomer.

46. The copolymer of claim 39 where the polymerizing is conducted in the further presence of a mercaptan chain transfer agent.

47. The copolymer of claim 46 where the chain transfer agent is selected from the group consisting of n-octyl mercaptan, t-octyl mercaptan, n-dodecyl mercaptan (NDM), t-dodecyl mercaptan, tridecyl mercaptan, tetradecyl mercaptan, hexadecyl mercaptan, and mixtures thereof.

48. The copolymer of claim 46 where the chain transfer agent is present in an amount up to about 800 ppm, based on the vinylaromatic monomer.

49. The copolymer of claim 39 where in polymerizing the vinylaromatic monomer with the polydiene, the polymerizing is conducted at a temperature between about 110° C. and about 185° C.

50. The copolymer of claim 39 where the weight ratio of vinylaromatic monomer to polydiene ranges from about 97:3 to about 85:15.

51. The copolymer of claim 39 where in recovering the product, the copolymerized product is high impact polystyrene (HIPS).

52. The copolymer of claim 39 where the polymerizing is conducted in the further presence of a cross-linking agent selected from the group consisting of polyfunctional monomers with two or more vinyl groups.

53. The copolymer of claim 40 where the polydiene is part of a styrene-butadiene-styrene block copolymer.

54. The copolymer of claim 53 wherein the styrene-butadiene-styrene block copolymer has a general formula:
S—B—S
where S is styrene and B is butadiene or isoprene.

55. The copolymer of claim 53 wherein the styrene-butadiene-styrene block copolymer has a general formula:
(SB)ₙX
where X stands for the residue of a coupling agent; and n is more than 1.

56. The copolymer of claim 53 wherein the styrene-butadiene-styrene block copolymer has a molecular weight range of from about 2,000 to 300,000 Daltons.

57. The copolymer of claim 53 wherein the styrene-butadiene-styrene block copolymer has a styrene content of at least 50 percent.

58. The copolymer of claim 53 wherein the styrene-butadiene-styrene block copolymer is a tapered block copolymer.

59. A foamed article made with the vinylaromatic monomer resin of claim 21.

60. The foamed article of claim 59, where the article is selected from the group consisting of insulation boards, cups, plates and food packaging articles.

61. A foamed article made with the vinylaromatic/diene graft copolymer of claim 39.

62. The foamed article of claim 61, where the article is selected from the group consisting of insulation boards, cups, plates and food packaging articles.
